(19) United States
(12) Patent Application Publication
(10) Pub. No.: US 2025/0138503 A1
(43) Pub. Date: May 1, 2025

(54) METHOD FOR IDENTIFYING A FIELD DEVICE TO BE OPERATED IN AUTOMATION TECHNOLOGY

(71) Applicant: Endress+Hauser Conducta GmbH+Co. KG, Gerlingen (DE)

(72) Inventors: Martin Lohmann, Gerlingen (DE); Thomas Alber, Stuttgart (DE); Oliver Durm, Benningen am Neckar (DE); Roman Griesser, Gerlingen (DE); Björn Haase, Stuttgart (DE); Stefan Robl, Hunxe (DE); Karsten Traub, Bietigheim-Bissingen (DE)

(21) Appl. No.: 18/925,687

(22) Filed: Oct. 24, 2024

(30) Foreign Application Priority Data
Oct. 25, 2023 (DE) 10 2023 129 378.8

(51) Int. Cl. G05B 19/042

(52) U.S. Cl. CPC G05B 19/0428; G05B 2219/24167; G05B 2219/25062

(57) ABSTRACT

A method for identifying a field device for automation technology includes providing an operator unit, which includes at least one order ticket with an access authorization for at least one of the field devices. The method also includes searching for accessible field devices with the operator unit using a wireless communications protocol. For each of the field devices accessible from the operator unit, a temporary communication connection between the operator unit and the relevant field deices is established using a wireless communications protocol, the order ticket is transmitted to the relevant field device, the access authorization for validity is checked by the field device, and the field devices that were able to successfully carry out the check for the validity of the access authorization are signaled.

### CROSS-REFERENCE TO RELATED APPLICATION

The present application is related to and claims the priority benefit of German Patent Application No. 10 2023 129 378.8, filed on Oct. 25, 2023, the entire contents of which are incorporated herein by reference.

### TECHNICAL FIELD

The present disclosure relates to a method for identifying a field device to be operated in automation technology.

### BACKGROUND

Field devices that are used in industrial installations are already known from the prior art. Field devices are often used in process automation technology, as well as in manufacturing automation technology. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill level, flow, etc. Actuators are used for influencing process variables. These are, for example, pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level.

A multitude of such field devices are produced and marketed by the Endress+Hauser group.

In modern industrial plants, field devices are usually connected to superordinate units via communications networks such as fieldbuses (Profibus®, Foundation® Fieldbus, HART®, etc.). Usually, the superordinate units are control systems (DCS) or control units, such as an SPC (stored program control). The superordinate units are used for, among other things, process control, process visualization, and process monitoring, as well as commissioning of the field devices. The measured values recorded by the field devices, such as by sensors, are transmitted via the respective bus system to a (or in some cases a plurality of) superordinate unit(s). In addition, data transmission from the superordinate unit via the bus system to the field devices is also required, such as for configuration and parameterization of field devices and for controlling actuators.

Mobile operator units can also be used to operate field devices. For example, there are control units that are connected to the fieldbus network. However, the operator unit can also communicate with the field devices via a wireless communications connection, in particular based upon a Bluetooth standard. The applicant produces and sells devices which, as so-called Bluetooth gateways, allow the control units to be coupled to the field devices. The field device is connected to a Bluetooth gateway via a wired connection, in particular using the HART or CDI communications standards, wherein the gateway establishes the wireless connection to the mobile operator unit. Alternatively, the field devices themselves have their own Bluetooth interface for direct connection to the operator unit.

If a mobile device, such as a smartphone or tablet, is used as an operator unit for wireless communication with the field devices, application programs, so-called apps, are available which make the operating functions for the field device available to the mobile device. To establish a connection between the field device and the mobile device, the application program displays those field devices that can be found by radio in the spatial environment of the mobile device. If several field devices are accessible, they can be listed by their names or sorted by the received signal strength.

From DE 10 2018 1026 08 A1, for example, it is known to provide a digital order ticket which is transmitted from a server to the mobile device and contains the access rights and the authorized tasks for the field device. This order ticket is transmitted when the connection is established with the field device. If authorization is available, the tasks contained in the order ticket, such as parameterization actions or execution of functional tests, can be processed with the field device.

If a large number of field devices are located in close proximity to the operator unit, the user is shown a long list of field devices with similar signal strength. The selection of the desired field device is time-consuming and involves manually searching for the correct name of the field device to be operated. If an error occurs, it will only be detected after selecting the field device, if the access rights for the selected field device are not available, and the connection is rejected by the field device.

### SUMMARY

Proceeding from this problem, the present disclosure is based upon the object of simplifying and accelerating the selection or locating of a field device for the purpose of subsequent operation.

A method for identifying a field device for automation technology includes providing an operator unit, which includes at least one order ticket with an access authorization for at least one of the field devices. The method also includes searching for accessible field devices with the operator unit using a wireless communications protocol. For each of the field devices accessible from the operator unit, a temporary communication connection between the operator unit and the relevant field deices is established using a wireless communications protocol, the order ticket is transmitted to the relevant field device, the access authorization for validity is checked by the field device, and the field devices that were able to successfully carry out the check for the validity of the access authorization are signaled.

The core of the method according to the present disclosure is that digital order tickets are used to quickly find the sought field device or devices. An order ticket contains access rights which are used one after the other for a login attempt on each field device accessible to the operator unit. If the access rights are successfully checked by a field device, a signaling takes place. “Signaling” means that a field device is identified, for example, in the operator unit or in another way. As a result, the sought field device or devices can be found significantly more quickly.

Examples of field devices mentioned in connection with the method according to the present disclosure have already been described in the introductory part of the description.

The operator unit is a mobile device that is not stationary and can be carried by a service technician, for example. In particular, the operator unit is a laptop, an operator unit in the sense of the “Field Xperts” marketed by the applicant, or a mobile device, e.g., a smartphone or a tablet, with a corresponding app.

An advantageous embodiment of the method provides that the steps of establishing the temporary communications connection, transmitting the order ticket, and checking the access authorization for validity be repeated for each of the order tickets present on the operator unit, and those field devices which were able to successfully carry out this validity check also be signaled. This means that the sought field devices for multiple work orders can be identified in one run.

In a first variant of the procedure, the signaling is carried out by the operator unit. It is thus provided that the operator unit be designed to create a list of all field devices found, with the operator unit marking, as a signal, each of the field devices in the list that was able to successfully complete the check for the validity of the access authorization. It can be provided to assign the signaled field devices to each of the order tickets available on the operator unit by means of different optical highlighting, for example, using different colors. In addition to the signaling, the sorting of the field devices in the list can also be adjusted so that suitable field devices that were able to successfully carry out the check of the validity of the access authorization are moved up in the list.

In a second variant of the method, the signaling is carried out by each of the field devices that successfully carried out the check. It can therefore be provided that each of the field devices emit an acoustic and/or optical signal as part of the signaling. For example, it can be provided that the display or a light on the housing of such a field device light up or blink.

According to an advantageous embodiment of the method, it is provided that, by means of the order ticket, the operator unit log on to one of the field devices that were able to successfully carry out the check for the validity of the access authorization, and establish a complete communications connection. In particular, the logging on takes place immediately, or only after a user interaction.

One embodiment of the method provides that the order ticket contain at least one operating action permitted for the operator unit, wherein, after logging on, the field device enables the operating actions, contained in the order ticket, for the operator unit. The operating action is, for example, a parameterization or configuration action, the initiation of a device (self) test, or the output of data, e.g., parameter data or a report.

According to a further development of the method, it is provided that, after logging on to the field device, the operator unit retrieve an item of location information of the field device and navigate an operator to the location of the field device. For this purpose, the operator unit uses a navigation system, e.g., GPS or triangulation, using for example a WLAN signal from several routers in the system. For the navigation, the operator unit may also use topographical data, such as a map, or other system data. For example, these data can be retrieved from a server before navigation.

### BRIEF DESCRIPTION OF THE DRAWING

The present disclosure is explained in greater detail with reference to the following FIGURE:

FIG. 1 shows an exemplary embodiment of the method according to the present disclosure.

### DETAILED DESCRIPTION

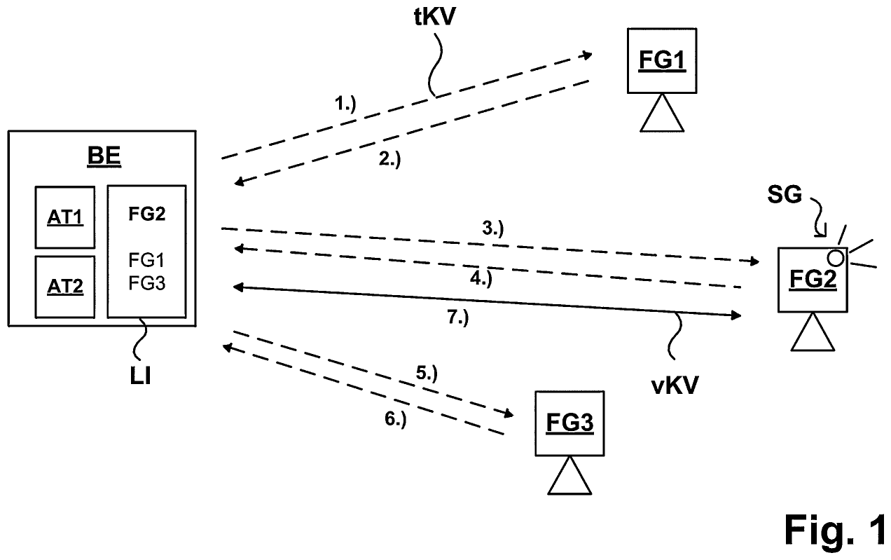

FIG. 1 shows a sequence of the method according to the present disclosure with the method steps 1.) to 7.). There are a plurality of field devices FG1, FG2, FG3 in a system. For operation, an operator unit BE in the form of a mobile device, such as, a smartphone, is used. Alternatively, other suitable types of operator units BE can be used.

In this exemplary embodiment, the software of the operator unit BE carries two order tickets AT1, AT2, each of which contains access authorizations and work orders for one or more field devices. The order tickets AT1, AT2 are sent, for example, from an order server to the operator unit BE. In an upstream method step, the operator unit uses a wireless standard, such as Bluetooth LE, to search for field devices FG1, FG2, FG3 that can be found in the area.

An attempt is then made to establish a connection with each of the field devices found using the first order ticket AT1. This happens in the background without the user having to take any action.

For this purpose, the operator unit BE, in method step 1.), establishes a temporary communications connection tKV with the field device FG1. A temporary communications connection allows the exchange of defined data between the operator unit BE and the field device FG1, but not full access of the operator unit BE to the field device FG1. The order ticket AT1 is then transferred to the field device FG1 and its access authorizations checked for validity.

If the access permissions are valid, access can be allowed. Feedback regarding validity occurs in method step 2.). If the validity is checked successfully, there is a signaling of the field device FG1. This means that the field device FG1 is identified, for example, by a display on the operator unit BE or by the field device FG1 itself. In this case, the feedback response is negative; the access data cannot be successfully checked for validity by the field device FG1.

Subsequently, the operator unit BE establishes a temporary communications connection tKV with the field device FG2 in method step 3.). The order ticket AT1 is then transferred to the field device FG2 and its access authorizations checked for validity.

Feedback regarding validity takes place in method step 4.). In this case, the feedback response is positive, and the access data can be successfully checked for validity by the field device FG2. The field device FG2 carries out the signaling SG, and a lamp attached to the field device housing blinks, this command is sent from the operator unit BE to the field device FG2. In addition, the field device FG2 is displayed at the top of a list LI displayed by the operator unit BE.

Subsequently, the operator unit BE establishes a temporary communications connection tKV with the field device FG3 in method step 5.). The order ticket AT1 is then transferred to the field device FG3 and its access authorizations checked for validity.

Feedback regarding validity occurs in method step 6.). In this case, the feedback response is negative; the access data cannot be successfully checked for validity by the field device FG3.

The described method steps 1.) to 6.) are repeated for the order ticket AT2. In this example, however, no suitable field device can be found for the order ticket AT2.

The user then selects the field device FG2 from the list LI. In method step 7.), the operator unit BE establishes a complete communications connection vKV with the field device FG2 and allows operation on the basis of the work orders contained in the order ticket AT1, which define permitted operating actions on the field device FG2, for example, parameterization. After the operation has been completed, the operator unit BE creates a confirmation ticket, which is sent back to the order server.

In the case in which the field device FG2 is far away from the operator unit BE and provides only a weak signal, the operator unit can request the location of the field device FG2 and navigate the user to the field device FG2.

The method enables the user to easily identify a sought field device and display it in a list LI on the operator unit BE. By signaling of the field device itself, the user can directly see where the field device is located in his environment so that he can carry out the planned and authorized work on the field device.

1. A method for identifying a field device to be operated in automation technology, comprising:
providing an operator unit, wherein at least one order ticket is present on the operator unit, wherein the order ticket has an access authorization for at least one of the field devices;
searching for accessible field devices by means of the operator unit using a wireless communications protocol;
carrying out the following steps for each of the field devices accessible from the operator unit;
establishing a temporary communications connection between the operator unit and the relevant field device using a wireless communications protocol;
transmitting the order ticket to the relevant field device;
checking the access authorization for validity by the field device;
signaling of those field devices that were able to successfully carry out the check for the validity of the access authorization.

2. The method according to claim 1, wherein the steps of establishing the temporary communications connection, transmitting the order ticket, and checking the access authorization for validity are repeated for each of the order tickets present on the operator unit, and wherein those field devices which were able to successfully carry out this validity check are also signaled.

3. The method according to claim 1, wherein the signaling is carried out by the operator unit.

4. The method according to claim 3, wherein the operator unit creates a list of all field devices found, and wherein the operator unit marks, as a signal, each of the field devices in the list which were able to successfully carry out the check for validity of the access authorization.

5. The method according to claim 1, wherein the signaling is carried out by each of the field devices which were able to successfully perform the check.

6. The method according to claim 5, wherein each of the field devices outputs an acoustic and/or optical signal as part of the signaling.

7. The method according to claim 1, wherein, using the order ticket, the operator unit logs on with one of the field devices which were able to successfully carry out the check for the validity of the access authorization, and establishes a complete communications connection.

8. The method according to claim 7, wherein the order ticket contains at least one operating action permitted for the operator unit, wherein the field device, after logging on, enables the operating actions, contained in the order ticket, for the operator unit.

9. The method according to claim 7, wherein the operator unit retrieves location information of the field device after logging on to the field device and navigates an operator to the location of the field device.
